(19) United States
(12) Patent Application Publication
(10) Pub. No.: US 2025/0242382 A1
(43) Pub. Date: Jul. 31, 2025

(54) THREE-DIMENSIONAL VIBRATING APPARATUS

(71) Applicants: An-Sung WANG, New Taipei City (TW); Wen-Tan WANG, New Taipei City (TW)

(72) Inventors: An-Sung WANG, New Taipei City (TW); Wen-Tan WANG, New Taipei City (TW); Ching-Chang WONG, Taipei City (TW); Yang-Han LEE, Taoyuan City (TW)

(73) Assignees: An-Sung WANG, New Taipei City (TW); Wen-Tan WANG, New Taipei City (TW)

(21) Appl. No.: 19/028,264

(22) Filed: Jan. 17, 2025

(30) Foreign Application Priority Data
Jan. 30, 2024 (TW) 113103611

(51) Int. Cl. B06B 1/04; H02K 33/16

(52) U.S. Cl. CPC B06B 1/045; H02K 33/16

(57) ABSTRACT

A three-dimensional vibrating apparatus includes a base plate and a loading plate unit. A loading surface of the loading plate unit is to be loaded with objects, and has a periphery. Three actuating units are disposed between the base plate and the loading plate unit. Each actuating unit includes a movable part, and a first resilient member interconnecting the movable part and the loading plate unit. The three actuating units are operable for driving the loading plate unit to move relative to the base plate in seven vibratory modes. In one of the seven vibratory modes, the objects are vibrated to move in a pair of opposite directions, and in each of the remaining six of the seven vibratory modes, the objects are vibrated to move simultaneously in a corresponding one of six different directions.

### CROSS-REFERENCE TO RELATED APPLICATION

This application claims priority to Taiwanese Invention Patent Application No. 113103611, filed on Jan. 30, 2024, the entire disclosure of which is incorporated by reference herein.

### FIELD

The disclosure relates to a vibrating apparatus, and more particularly to a three-dimensional vibrating apparatus.

### BACKGROUND

Referring to FIG. 1, a conventional vibrating apparatus 9 as disclosed in U.S. Pat. No. 8,550,233B2 includes a support 91, a plate 92 connected to the support 91, and three actuators 93 (only two are shown) connected to the support 91, thereby driving a plurality of objects (not shown) on the plate 92 to be moved and scattered.

The plate 92 is fixed to the support 91, and the three actuators 93 (only two are shown) are arranged in three-dimensional directions relative to each other. When the actuators 93 transmit vibrating energy through the support 91 to the plate 92, some of the vibrating energy transmitted to the plate 92 is likely to be lost. Furthermore, because the farther away a portion of the plate 92 is from the support 91, the less vibration of the portion of the plate 92, the plate 92 is restricted in area in order to limit the distance between any portion of the plate 92 and the support 91.

### SUMMARY

Therefore, an object of the disclosure is to provide a three-dimensional vibrating apparatus that can alleviate at least one of the drawbacks of the prior art.

According to the disclosure, the three-dimensional vibrating apparatus includes a base unit, a loading plate unit, and at least three actuating units.

The base unit includes a base plate.

The loading plate unit is spaced apart from the base plate in a top-bottom direction, and has a loading surface that is adapted to be loaded with a plurality of objects, and that has a periphery.

The at least three actuating units are disposed between the base plate and the loading plate unit, are connected to the base plate, are arranged coplanarly, and are proximate to the periphery of the loading surface. Each of the at least three actuating units includes a movable part that is upwardly and downwardly movable relative to the base plate in the top-bottom direction, and a first resilient member that interconnects the movable part and the loading plate unit.

The movable parts of the at least three actuating units are controllable in frequencies and amplitudes independently from each other.

The movable part of each of the at least three actuating units is independently operable, and the at least three actuating units are cooperatively operable for driving the loading plate unit to move relative to the base plate in at least seven vibratory modes.

In one of the at least seven vibratory modes, the objects are vibrated to move in at least one pair of opposite directions, and in each of the remaining six of the at least seven vibratory modes, the objects are vibrated to move simultaneously in a corresponding one of at least six different directions.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic side view illustrating a conventional vibrating apparatus.

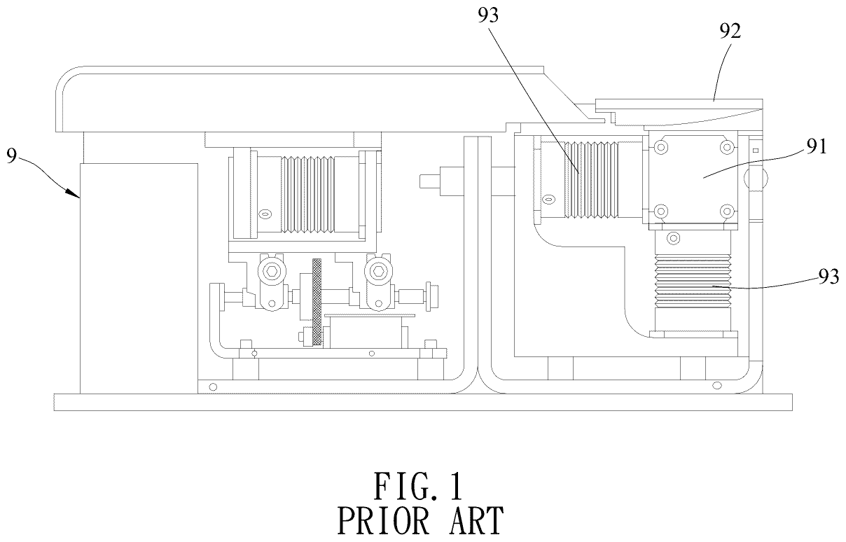

FIG. 2 is a schematic fragmentary perspective view illustrating a three-dimensional vibrating apparatus according to an embodiment of the disclosure.

FIG. 3 is an exploded perspective view of the embodiment illustrating a base unit, a loading plate unit, and actuating units of the three-dimensional vibrating apparatus.

FIG. 4 is a top view of the embodiment illustrating the actuating units arranged along a contour of a polygon, the polygon which is square.

FIG. 5 is a sectional view taken along line V-V of FIG. 4.

FIG. 6A to FIG. 6C illustrate the actuating units cooperatively driving movement of the loading plate unit to move an object loaded on the loading plate unit.

FIG. 7A to FIG. 7I illustrate nine vibratory modes of the three-dimensional vibrating apparatus of the embodiment.

FIG. 8A to FIG. 8C illustrate other three vibratory modes of the three-dimensional vibrating apparatus of the embodiment.

FIG. 9 illustrates another vibratory mode of the three-dimensional vibrating apparatus of the embodiment.

FIG. 10 is a view similar to FIG. 4, but illustrating three of the actuating units arranged along a contour of a triangle.

FIG. 11 illustrates seven vibratory modes of the three-dimensional vibrating apparatus that includes only three actuating units.

FIG. 12 is a view similar to FIG. 4, but illustrating eight of the actuating units arranged along a contour of a square.

FIG. 13 is a view similar to FIG. 4, but illustrating four of the actuating units arranged along a contour of a rhombus.

FIG. 14 is a top view of a variant embodiment illustrating ten of the actuating units arranged along a contour of a rectangle.

FIG. 15 is a view similar to FIG. 4, but illustrating five of the actuating units arranged along a contour of a pentagon.

FIG. 16 is a view similar to FIG. 4, but illustrating six of the actuating units arranged along a contour of a hexagon.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

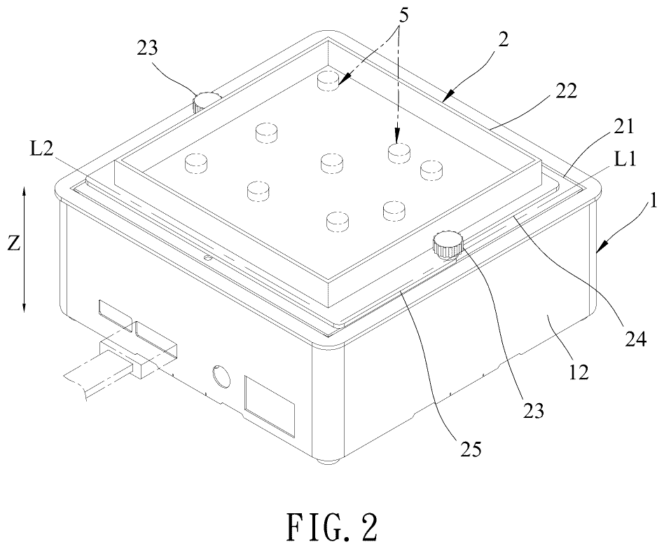

Referring to FIGS. 2 to 5, a three-dimensional vibrating apparatus according to an embodiment of the disclosure includes a base unit 1, a loading plate unit 2, four actuating units 3, and a control unit 4.

The base unit 1 includes a base plate 11, and a surrounding wall 12 that surrounds and extends upwardly from the base plate 11 in a top-bottom direction (Z).

The loading plate unit 2 is spaced apart from the base plate 11 in the top-bottom direction (Z). The loading plate unit 2 includes a connection seat 21, a loading plate 22, two securing members 23, a U-shaped first plate member 24 and a U-shaped second plate member 25.

In this embodiment, the connection seat 21 is a rectangular and hollow frame.

The loading plate 22 is slidable relative to the connection seat 21 along a first horizontal axis (L1) and removably connected to the connection seat 21, and is adapted to be loaded with a plurality of objects 5. The loading plate 22 has a loading surface 221 that is adapted to be loaded with the objects 5, and that has a periphery 222.

The two securing members 23 are spaced apart from each other along a second horizontal axis (L2). Each of the securing members 23 has a head portion, and a stem portion that extends downwardly from the head portion and extending removably through the connection seat 21. A diameter of the stem portion is smaller than a diameter of the head portion. In this embodiment, the first horizontal axis (L1) and the second horizontal axis (L2) are perpendicular to each other.

The first plate member 24 and the second plate member 25 are connected to and cooperatively surround the loading plate 22. In this embodiment, the first plate member 24 and the second plate member 25 cooperatively surround the periphery 222 of the loading surface 221. The first plate member 24 has a U-shaped outer periphery that has two opposite ends spaced apart from each other. A first distance (d1) between the opposite ends of the outer periphery of the first plate member 24 is smaller than a distance 20 between the stem portions of the securing members 23, so that the first plate member 24 is allowed to pass between the stem portions of the securing members 23. The second plate member 25 has a U-shaped outer periphery that has two opposite ends spaced apart from each other. A distance (d2) between the opposite ends of the outer periphery of the second plate member 25 is greater than the distance 20 between the stem portions of the securing members 23. The two opposite ends of the outer periphery of the first plate member 24 are connected respectively to the two opposite ends of the outer periphery of the second plate member 25. Joints between the outer periphery of the first plate member 24 and the outer periphery of the second plate member 25 abut respectively against the securing members 23. The head portion of each of the securing members 23 abuts removably a respective one of the two opposite ends of the outer periphery of the second plate member 25 against the connection seat 21.

The actuating units 3 are disposed between the base plate 11 and the loading plate unit 2, are connected to the base plate 11, are arranged coplanarly, and are proximate to the periphery 222 of the loading surface 221. In this embodiment, each of the actuating units 3 is a voice coil motor, and includes a movable part 32, a stationary part 31, a first resilient member 33, and a second resilient member 34. The movable part 32 is upwardly and downwardly movable relative to the base plate 11 in the top-bottom direction (Z). The stationary part 31 is connected to the base plate 11 and is sleeved on the movable part 32. The first resilient member 33 interconnects the connection seat 21 of the loading plate unit 2 and the movable part 32. The connection seat 21 is connected to the first resilient member 33 of each of the actuating units 3. The second resilient member 34 is disposed between and abuts against the stationary member 31 and the first resilient member 33. In this embodiment, each of the actuating units 3 is aligned with an adjacent one of the actuating units 3 along the first horizontal axis (L1), and is aligned with an opposite adjacent one of the actuating units 3 along the second horizontal axis (L2). The bottom ends of the stationary parts 31 of the actuating units 3 are coplanar with each other and are connected to the base plate 11.

It should be noted that each of the actuating units 3 is not limited to the voice coil motor. In some embodiments, each of the actuating units 3 may be a solenoid valve. As long as each of the actuating units 3 may provide a telescopic function in the top-bottom direction equivalently to a structure of the movable part 32, the structure of each of the actuating units 3 is not limited hereto.

Specifically, the movable parts 32 of the actuating units 3 are controllable in frequencies and amplitudes independently from each other. The movable part 32 of each of the actuating units 3 is independently operable, and the actuating units 3 are cooperatively operable for driving the loading plate unit 2 to move relative to the base plate 11.

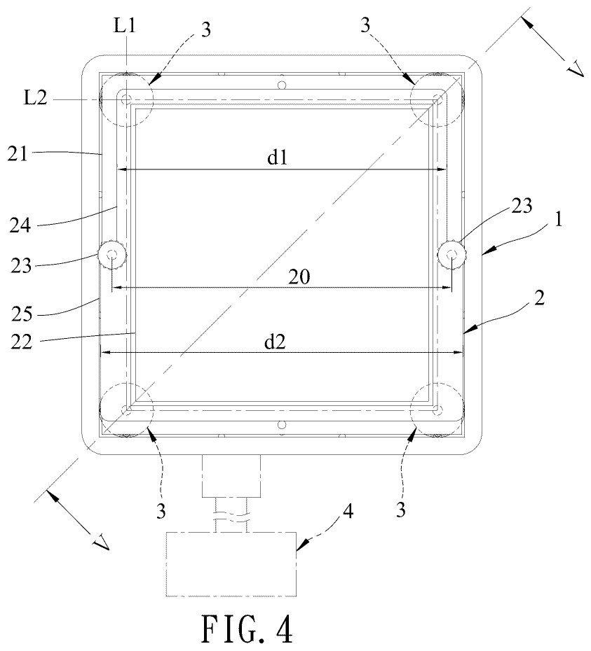

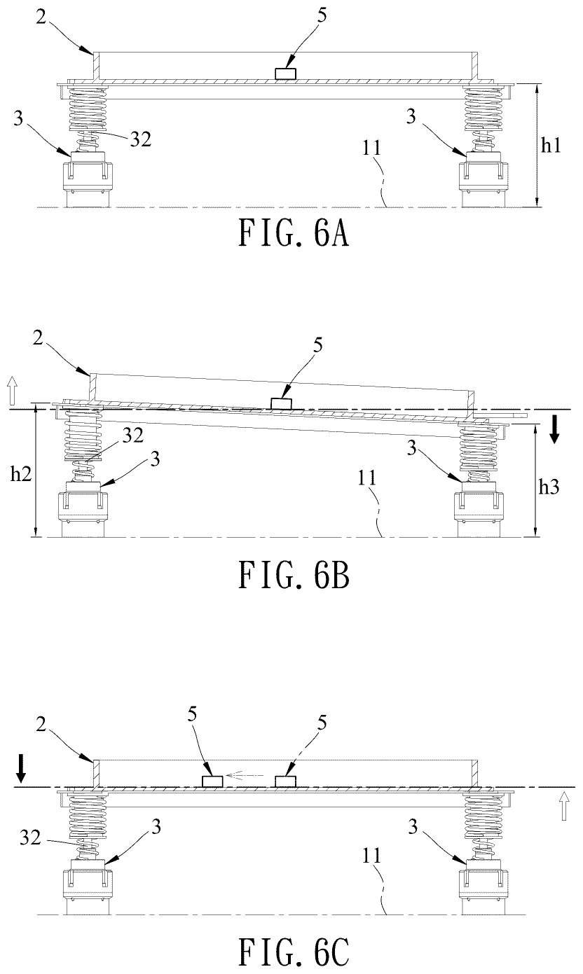

Referring to FIGS. 4 and 6A to 6C, the movable part 32 of each of the actuating units 3 is upwardly and downwardly movable relative to the base plate 11 among a normal position, a top position, and a bottom position. For each of the actuating units 3, a first height (h1) between a top end of the movable part 32 and the base plate 11 when the movable part 32 is in the normal position is smaller than a second height (h2) between the top end of the movable part 32 and the base plate 11 when the movable part 32 is in the top position, and is larger than a third height (h3) between the top end of the movable part 32 and the base plate 11 when the movable part 32 is in the bottom position. As a result, when the movable part 32 of each of the actuating units 3 is in the normal position, the loading plate unit 2 is parallel to the base plate 11. When the movable part 32 of some of the actuating units 3 is in one of the top position and the bottom position, the loading plate unit 2 is driven to be oblique relative to the base plate 11.

The actuating units 3 are arranged along a contour of a polygon which has a plurality of vertices. At least some of the actuating units 3 are disposed at the vertices of the polygon. In this embodiment, the four actuating units 3 are arranged along a contour of a square, and are respectively disposed at four vertices of the square.

The control unit 4 is electrically connected to the actuating units 3, and is operable to activate and inactivate the actuating units 3, and to control frequencies and amplitudes of the movable part 32 of each of the actuating units 3.

Referring back to FIGS. 6A to 6C, two of the actuating units 3 are taken as an example to be cooperatively operable for driving the loading plate unit 2 to move relative to the base plate 11, thereby illustrating a movement process of the object 5 (only one is shown).

As shown in FIG. 6A, the movable part 32 of each of the two actuating units 3 is in the normal position.

As shown in FIGS. 6A and 6B, when the movable part 32 of the actuating unit 3 on the left side of FIG. 6B is moved slowly and upwardly from the normal position to the top position with respect to the base plate 11 along a white arrow, and when the movable part 32 of the actuating unit 3 on the right side of FIG. 6B is moved slowly and downwardly from the normal position to the bottom position with respect to the base plate 11 along a dark arrow, the loading plate unit 2 is oblique relative to the base plate 11. Because the movable parts 32 of the actuating units 3 are slowly moved, the object 5 is prevented from moving relative to the loading plate unit 2 while the loading plate unit 2 is oblique relative to the base plate 11.

As shown in FIGS. 6B and 6C, when the movable part 32 of the actuating unit 3 on the left side of FIG. 6C is moved quickly and downwardly from the top position to the normal position with respect to the base plate 11 along the dark arrow, and when the movable part 32 of the actuating unit 3 on the right side of FIG. 6B is moved quickly and upwardly from the bottom position to the normal position with respect to the base plate 11 along the white arrow, the loading plate unit 2 is quickly moved parallel to the base plate 11. Because the movable parts 32 of the actuating units 3 are quickly moved, the object 5 is sprung and moved leftward relative to the loading plate unit 2.

For each of the actuating units 3, a vibration cycle is that the movable part 32 moves away from and back to the normal position. In this embodiment, the movable part 32 of each of the actuating units 3 is controlled independently by the control unit 4 in frequencies, amplitudes, and movement directions for driving the loading plate unit 2 to move the objects 5. For example, when the loading plate unit 2 is driven to rotate about a horizontal Y-axis (not shown) perpendicular to the top-bottom direction (Z), the objects 5 are vibrated to be flipped over along the top-bottom direction (Z) and to be moved along a horizontal X-axis (not shown) perpendicular to the horizontal Y-axis and the top-bottom direction (Z). When the loading plate unit 2 is driven to rotate about the horizontal X-axis (not shown), the objects 5 are vibrated to be flipped over along the top-bottom direction (Z) and to be moved along a horizontal Y-axis (not shown). By virtue of the three-dimensional vibrating apparatus of the disclosure, the objects 5 are allowed to be freely moved in three-dimensional directions.

Specifically, the four actuating units 3 are cooperatively operable for driving the loading plate unit 2 to move relative to the base plate 11 in thirteen vibratory modes. In each of eight of the thirteen vibratory modes, the objects 5 are vibrated to move simultaneously in a respective one of eight different directions. In each of another three of the thirteen vibratory modes, the objects 5 are vibrated to move in a respective pair of three different pairs of opposite directions. In another one of the thirteen vibratory modes, the objects 5 are vibrated to move in two different pairs of opposite directions, and in the remaining one of the thirteen vibratory modes, the objects 5 are vibrated to move in a circular direction.

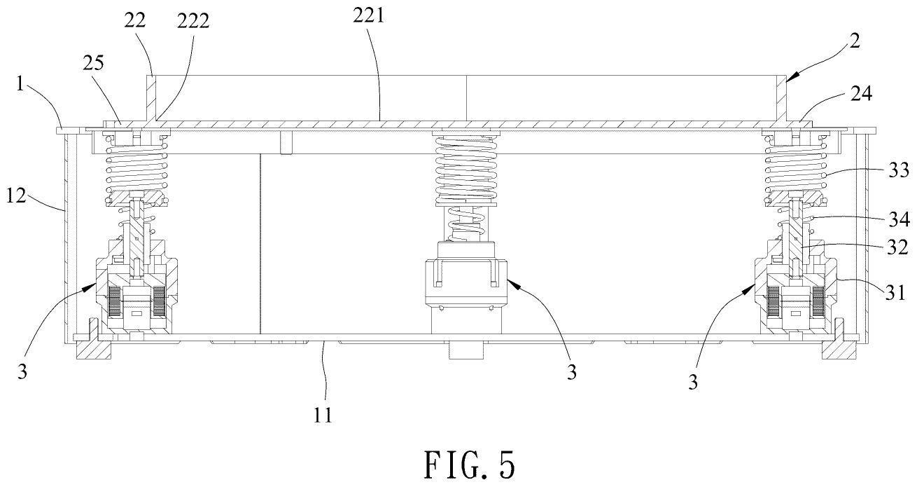

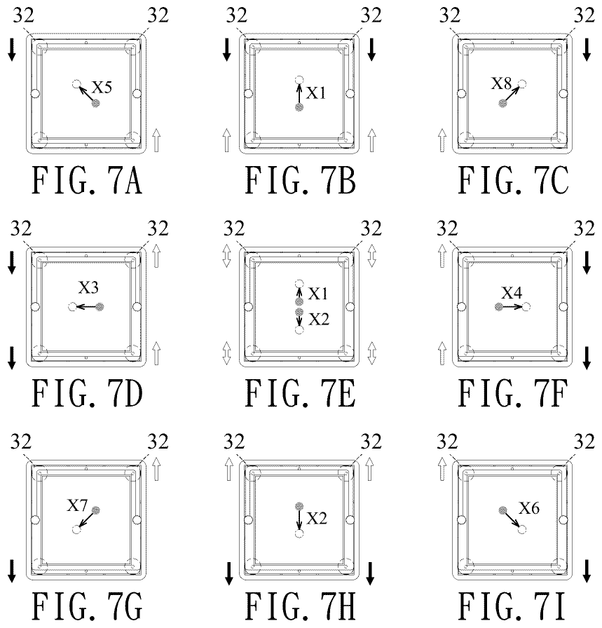

Referring to FIGS. 7A, 7B, 7C, 7D, 7F, 7G, 7H, 7I in combination with FIG. 5, in each of the eight of the thirteen vibratory modes, the four actuating units 3 are cooperatively operable for driving the loading plate unit 2 to vibrate the objects 5 (only one is shown) to move simultaneously in a respective one of a first direction (X1), a second direction (X2) opposite to the first direction (X1), a third direction (X3) perpendicular to the first direction (X1), a fourth direction (X4) opposite to the third direction (X3), a fifth direction (X5) spaced equiangularly from the first direction (X1) and the third direction (X3), a sixth direction (X6) opposite to the fifth direction (X5), a seventh direction (X7) spaced equiangularly from the second direction (X2) and the third direction (X3), and an eighth direction (X8) opposite to the seventh direction (X7). In this embodiment, the first direction (X1), the second direction (X2), the third direction (X3), the fourth direction (X4), the fifth direction (X5), the sixth direction (X6), the seventh direction (X7), and the eighth in direction (X8) are coplanar with each other. The dark circle represents the object 5 before movement, and the white circle represents the object 5 after movement. A dark arrow indicates that the movable part 32 of a respective one of the actuating units 3 is moved from the normal position to the bottom position, and a white arrow indicates that the movable part 32 of a respective one of the actuating units 3 is moved from the normal position to the top position.

FIG. 7A illustrates a first vibratory mode of the thirteen vibratory modes. In the first vibratory mode, the movable part 32 at the upper left corner is moved cyclically along the dark arrow, and the movable part 32 at the lower right corner is moved cyclically along the white arrow, so that the objects 5 (only one is shown) are vibrated to move simultaneously in the fifth direction (X5).

FIG. 7B illustrates a second vibratory mode of the thirteen vibratory modes. In the second vibratory mode, the movable parts 32 at the upper left corner and at the upper right corner are moved synchronously and cyclically along the dark arrows, and the movable parts 32 at the lower left corner and at the lower right corner are moved synchronously and cyclically along the white arrows, so that the objects 5 (only one is shown) are vibrated to move simultaneously in the first direction (X1).

FIG. 7C illustrates a third vibratory mode of the thirteen vibratory modes. In the third vibratory mode, the movable part 32 at the upper right corner is moved cyclically along the dark arrow, and the movable part 32 at the lower left corner is moved cyclically along the white arrow, so that the objects 5 (only one is shown) are vibrated to move simultaneously in the eighth direction (X8).

FIG. 7D illustrates a fourth vibratory mode of the thirteen vibratory modes. In the fourth vibratory mode, the movable parts 32 at the upper left corner and at the lower left corner are moved synchronously and cyclically along the dark arrows, and the movable parts 32 at the upper right corner and at the lower right corner are moved synchronously and cyclically along the white arrows, so that the objects 5 (only one is shown) are vibrated to move simultaneously in the third direction (X3).

FIG. 7F illustrates a sixth vibratory mode of the thirteen vibratory modes. In the sixth vibratory mode, the movable parts 32 at the upper left corner and at the lower left corner are moved synchronously and cyclically along the white arrows, and the movable parts 32 at the upper right corner and at the lower right corner are moved synchronously and cyclically along the dark arrows, so that the objects 5 (only one is shown) are vibrated to move simultaneously in the fourth direction (X4).

FIG. 7G illustrates a seventh vibratory mode of the thirteen vibratory modes. In the seventh vibratory mode, the movable part 32 at the lower left corner is moved cyclically along the dark arrow, and the movable part 32 at the upper right corner is moved cyclically along the white arrow, so that the objects 5 (only one is shown) are vibrated to move simultaneously in the seventh direction (X7).

FIG. 7H illustrates an eighth vibratory mode of the thirteen vibratory modes. In the eighth vibratory mode, the movable parts 32 at the upper left corner and at the upper right corner are moved synchronously and cyclically along the white arrows, and the movable parts 32 at the lower left corner and at the lower right corner are moved synchronously and cyclically along the dark arrows, so that the objects 5 (only one is shown) are vibrated to move simultaneously in the second direction (X2).

FIG. 7I illustrates a ninth vibratory mode of the thirteen vibratory modes. In the ninth vibratory mode, the movable part 32 at the upper left corner is moved cyclically along the white arrows, and the movable part 32 at the lower right corner is moved cyclically along the dark arrows, so that the objects 5 (only one is shown) are vibrated to move simultaneously in the sixth direction (X6).

FIG. 7E illustrates a fifth vibratory mode of the thirteen vibratory modes. In the fifth vibratory mode, the movable parts 32 at the four corners are moved synchronously and cyclically along the double-headed arrows, so that the objects are vibrated to move respectively in the first direction (X1) and the second direction (X2).

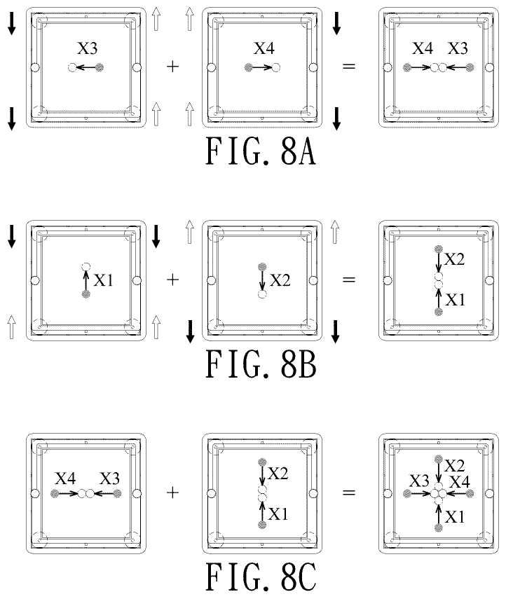

FIG. 8A illustrates a tenth vibratory mode of the thirteen vibratory modes. The tenth vibratory mode is a combination of the fourth vibratory mode and the sixth vibratory mode, so that the objects 5 are moved along the third direction (X3) and the fourth direction (X4) to cluster together.

FIG. 8B illustrates an eleventh vibratory mode of the thirteen vibratory modes. The eleventh vibratory mode is a combination of the second vibratory mode and the eighth vibratory mode, so that the objects 5 are moved along the first direction (X1) and the second direction (X2) to cluster together.

FIG. 8C illustrates a twelfth vibratory mode of the thirteen vibratory modes. The twelfth vibratory mode is a combination of the tenth vibratory mode and the eleventh vibratory mode, so that the objects 5 are moved along the first direction (X1), the second direction (X2), the third direction (X3), and the fourth direction (X4) to cluster together.

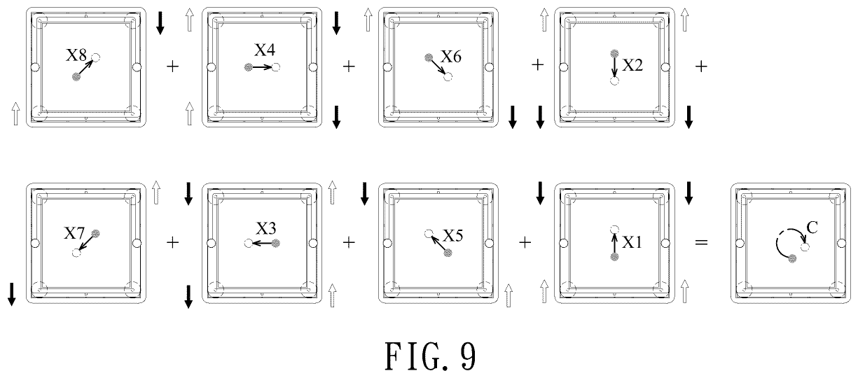

FIG. 9 illustrates a thirteenth vibratory mode of the thirteen vibratory modes. The thirteenth vibratory mode is a combination of the first vibratory mode, the second vibratory mode, the third vibratory mode, the fourth vibratory mode, the sixth vibratory mode, the seventh vibratory mode, the eighth vibratory mode, and the ninth vibratory mode, so that the objects 5 (only one is shown) are moved in a circular direction (C).

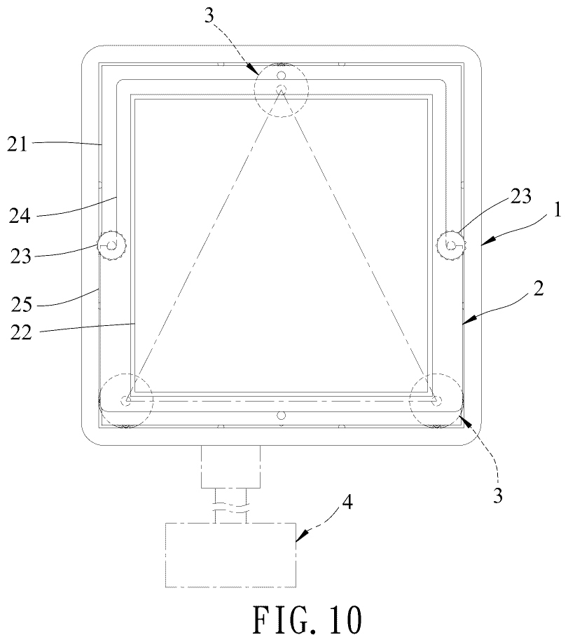

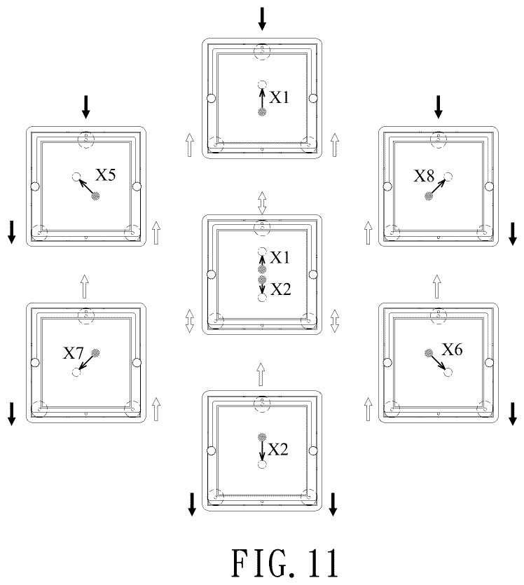

It should be noted that the quantity of the actuating units 3 is not limited to four. In other variant embodiments, as shown in FIG. 10, three of the actuating units 3 are arranged along a contour of a triangle and are respectively disposed on the three vertices of the triangle. The three actuating units 3 are cooperatively operable for driving the loading plate unit 2 to move relative to the base plate 11 in seven vibratory modes. As shown in FIG. 11, in one of the seven vibratory modes, the objects 5 are vibrated to move in a pair of opposite directions, and in each of the remaining six of the seven vibratory modes, the objects 5 (only one is shown) are vibrated to move simultaneously in a corresponding one of six different directions.

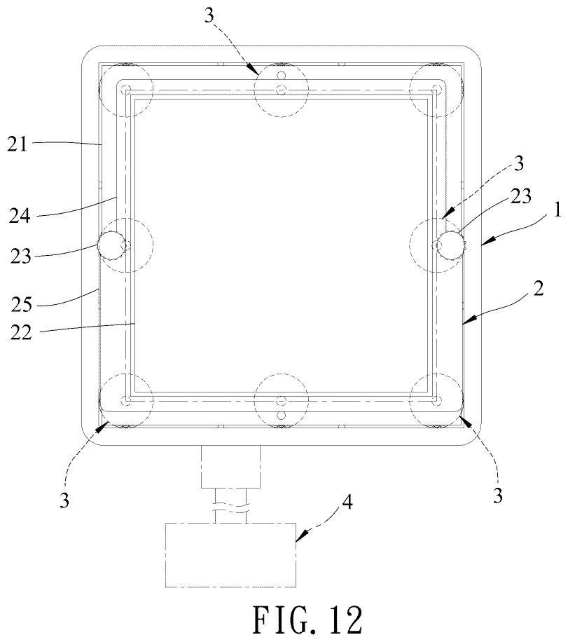

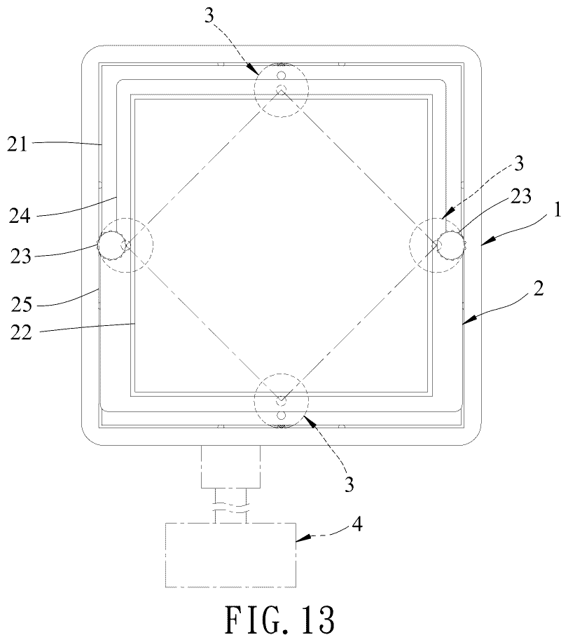

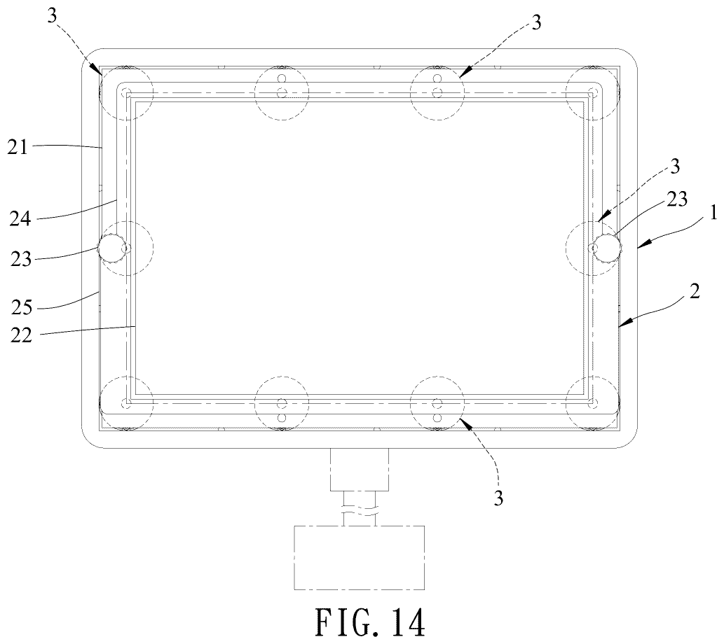

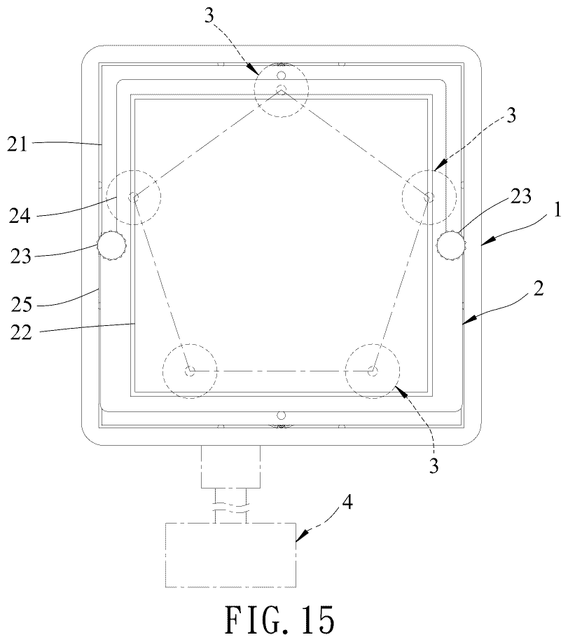

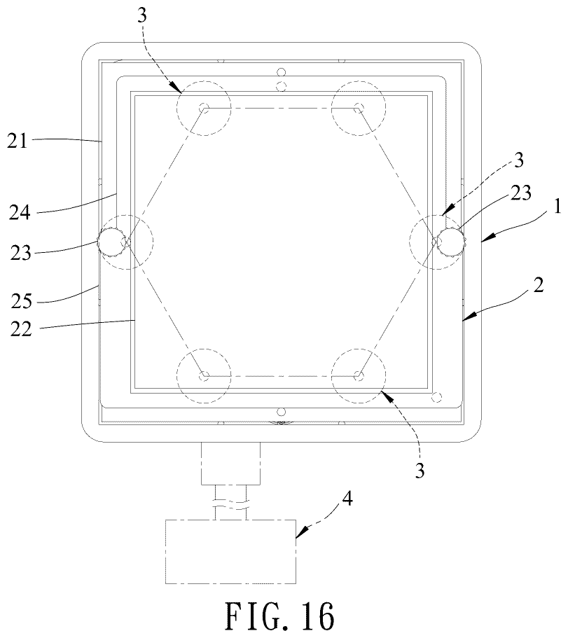

As shown in FIG. 12, eight of the actuating units 3 are arranged along a contour of a square. As shown in FIG. 13, four of the actuating units 3 are arranged along a contour of a rhombus. As shown in FIG. 14, ten of the actuating units 3 are arranged along a contour of a rectangle. As shown in FIG. 15, five of the actuating units 3 are arranged along a contour of a pentagon. As shown in FIG. 16, six of the actuating units 3 are arranged along a contour of a hexagon.

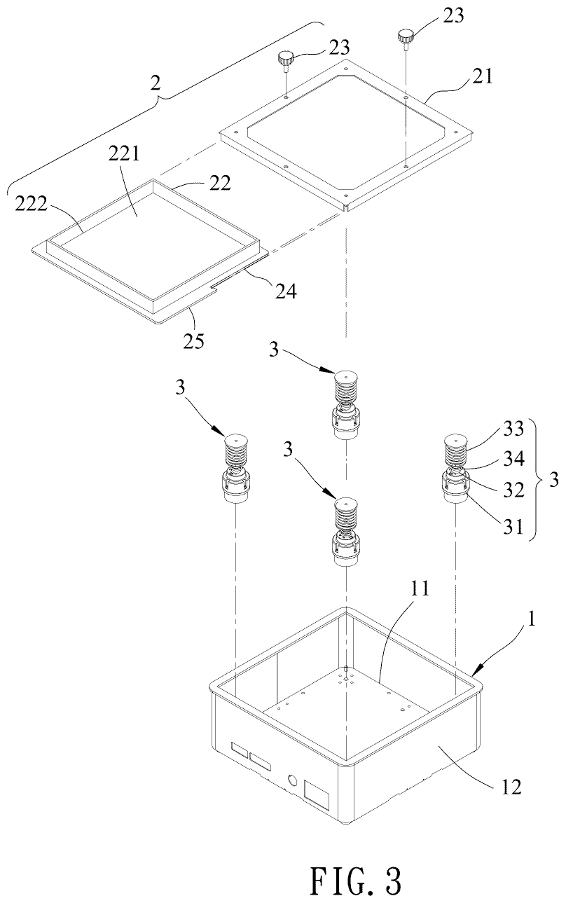

Referring back to FIGS. 2 and 3, loading of the objects 5 on the loading plate 22 is not limited to the loading surface 221. In other variant embodiments, the loading plate 22 may have a plurality of recesses (not shown) for receiving the objects 5. When the head portions of the securing members 23 are released respectively from the two opposite ends of the outer periphery of the second plate member 25, the second plate member 25 and the connection seat 21 are loosened from each other, so that the loading plate 22 is allowed to be removed from the connection seat 21. To assemble the loading plate 22 to the connection seat 21, the loading plate 22 is slid to the connection seat 21 such that the opposite ends of the outer periphery of the first plate member 24 pass between the stem portions of the securing members 23. When the opposite ends of the outer periphery of the second plate member 25 respectively abut against the stem portions of the securing members 23, the head portion of each of the securing members 23 is driven to abut the respective one of the two opposite ends of the outer periphery of the second plate member 25 against the connection seat 21, such that the loading plate 22 is fixed to the connection seat 21.

The three-dimensional vibrating apparatus of the disclosure has the following advantages.
1. For each of the actuating units 3, the first resilient member 33 is flexible and interconnects the movable part 32 and the loading plate unit 2, such that the movable part 32 is flexibly connected to the connection seat 21 of the loading plate unit 2 by the first resilient member 33. As a result, the upward and downward movements of the movable parts 32 of the actuating units 3 directly drive the first resilient members 33 of the actuating units 3 and the loading plate unit 2 to move together therewith. Furthermore, because the first resilient member 33 of each of the actuating units 3 is flexible and interconnects the movable part 32 and the loading plate unit 2, the loading plate unit 2 is floatable relative to the base plate 11. In addition, the loading plate unit 2 is directly connected to the first resilient member 33 of each of the actuating units 3, thereby reducing energy loss and increasing vibration efficiency. Because there is no other component disposed between the loading plate unit 2 and the actuating units 3, the overall dimensions of the three-dimensional vibrating apparatus may be reduced.
2. Because the first resilient member 33 of each of the actuating units 3 is flexible and interconnects the movable part 32 and the loading plate unit 2, when the movable part 32 of one of the actuating units 3 is moved upwardly and downwardly relative to the base plate 11 in the top-bottom direction (Z), the movable parts 32 of the other actuating units 3 remain stationary. Because the movable part 32 of each of the actuating units 3 is independently operable and controllable in frequencies, amplitudes, and movement directions, the actuating units 3 are cooperatively operable for driving the loading plate unit 2 to move relative to the base plate 11 in at least seven vibratory modes, thereby vibrating the objects 5 to move in three-dimensional directions.
3. Because the actuating units 3 are disposed proximate to the periphery 222 of the loading surface 221, the size of the loading plate 22 may change such that the loading surface 221 loaded with the objects 5 is not limited in area.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A three-dimensional vibrating apparatus comprising:
a base unit including a base plate;
a loading plate unit spaced apart from said base plate in a top-bottom direction, and having a loading surface that is adapted to be loaded with a plurality of objects, and that has a periphery; and
at least three actuating units disposed between said base plate and said loading plate unit, connected to said base plate, arranged coplanarly, and proximate to said periphery of said loading surface, each of said at least three actuating units including
a movable part that is upwardly and downwardly movable relative to said base plate in the top-bottom direction, and
a first resilient member that interconnects said movable part and said loading plate unit;
wherein said movable parts of said at least three actuating units are controllable in frequencies and amplitudes independently from each other;
wherein said movable part of each of said at least three actuating units is independently operable, and said at least three actuating units are cooperatively operable for driving said loading plate unit to move relative to said base plate in at least seven vibratory modes; and
wherein, in one of the at least seven vibratory modes, the objects are vibrated to move in at least one pair of opposite directions, and in each of the remaining six of the at least seven vibratory modes, the objects are vibrated to move simultaneously in a corresponding one of at least six different directions.

2. The three-dimensional vibrating apparatus as claimed in claim 1, wherein:
said at least three actuating units includes four actuating units;
said four actuating units are cooperatively operable for driving said loading plate unit to move relative to said base plate in thirteen vibratory modes; and
in each of eight of the thirteen vibratory modes, the objects are vibrated to move simultaneously in a respective one of eight different directions, in each of another three of the thirteen vibratory modes, the objects are vibrated to move in a respective pair of three different pairs of opposite directions, in another one of the thirteen vibratory modes, the objects are vibrated to move in two different pairs of opposite directions, and in the remaining one of the thirteen vibratory modes, the objects are vibrated to move in a circular direction.

3. The three-dimensional vibrating apparatus as claimed in claim 2, wherein in each of the eight of the vibratory modes, said four actuating units are cooperatively operable for driving said loading plate unit to vibrate the objects to move simultaneously in a respective one of a first direction, a second direction opposite to the first direction, a third direction perpendicular to the first direction, a fourth direction opposite to the third direction, a fifth direction spaced equiangularly from the first direction and the third direction, a sixth direction opposite to the fifth direction, a seventh direction spaced equiangularly from the second direction and the third direction, and an eighth direction opposite to the seventh direction.

4. The three-dimensional vibrating apparatus as claimed in claim 1, wherein:
said at least three actuating units are arranged along a contour of a polygon which has a plurality of vertices; and
at least some of said at least three actuating units are disposed at the vertices of the polygon.

5. The three-dimensional vibrating apparatus as claimed in claim 1, wherein each of said at least three actuating units is a voice coil motor, and further includes
a stationary part that is connected to said base plate and that is sleeved on said movable part, and
a second resilient member that is disposed between and abuts against said stationary part and said first resilient member.

6. The three-dimensional vibrating apparatus as claimed in claim 1, further comprising a control unit that is electrically connected to said at least three actuating units, and that is operable to activate and inactivate said at least three actuating units, and to control frequencies and amplitudes of said movable part of each of said at least three actuating units.

7. The three-dimensional vibrating apparatus as claimed in claim 1, wherein said loading plate unit includes
a connection seat that is connected to said first resilient member of each of said at least three actuating units, and
a loading plate that is removably connected to said connection seat and that is adapted to be loaded with the objects.

8. The three-dimensional vibrating apparatus as claimed in claim 7, wherein:
said loading plate is slidable relative to said connection seat;
said loading plate unit further includes
two securing members, each of said securing members having a head portion, and a stem portion that extends downwardly from said head portion and extending removably through said connection seat, a diameter of said stem portion being smaller than a diameter of said head portion, and
a U-shaped first plate member and a U-shaped second plate member connected to and cooperatively surrounding said loading plate;
said first plate member has a U-shaped outer periphery that has two opposite ends spaced apart from each other, a first distance between said opposite ends of said outer periphery of said first plate member being smaller than a distance between said stem portions of said securing members;
said second plate member has a U-shaped outer periphery that has two opposite ends spaced apart from each other, a distance between said opposite ends of said outer periphery of said second plate member being greater than the distance between said stem portions of said securing members;
said two opposite ends of said outer periphery of said first plate member are connected respectively to said two opposite ends of said outer periphery of said second plate member, joints between said outer periphery of said first plate member and said outer periphery of said second plate member abutting respectively against said securing members; and
said head portion of each of said securing members abuts removably a respective one of said two opposite ends of said outer periphery of said second plate member against said connection seat.

9. The three-dimensional vibrating apparatus as claimed in claim 1, wherein:
said movable part of each of said at least three actuating units is upwardly and downwardly movable relative to said base plate among a normal position, a top position, and a bottom position; and
for each of said at least three actuating units, a first height between a top end of said movable part and said base plate when said movable part is in the normal position is smaller than a second height between said top end of said movable part and said base plate when said movable part is in the top position, and is larger than a third height between said top end of said movable part and said base plate when said movable part is in the bottom position.
